(19) United States
(12) Patent Application Publication
(10) Pub. No.: US 2005/0286528 A1
(43) Pub. Date: Dec. 29, 2005

(54) Method and system for implementing an inter-working function

(75) Inventor: Sami Kekki, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/758,544

(22) Filed: Jan. 16, 2004

Related U.S. Application Data
(63) Continuation of application No. PCT/FI02/00620, filed on Jul. 9, 2002.

(30) Foreign Application Priority Data
Aug. 22, 2001 (FI) 20011692
Oct. 17, 2001 (FI) 20012018

(51) Int. Cl. H04L 12/28

(52) U.S. Cl. 370/395.1; 370/395.61

(57) ABSTRACT

The area of the invention belongs to the transport technologies in UTRAN. There are two transport technologies in use in the transport networks (domains) and the Network Elements in these two different domains need to be able communicate with each other. The baseline for the invention is that the existing ATM/AAL2 network and its 3GPP specifications should be left untouched as much as possible. In UTRAN based on ATM/AAL2 transport there is AAL2 Signalling used as ALCAP. the invention is based on the idea that the existing ALCAP, e.g. Q.2630 is used not only in the ATM/AAL2 domain as an ALCAP, i.e. no changes to the existing specifications, but also as an auxiliary control protocol in the IP transport domain. This is accomplished by using a user defined information element of said existing ALCAP.

### FIELD OF THE INVENTION

The present invention relates to telecommunication systems. In particular, the present invention relates to a novel and improved method and system for implementing a protocol inter-working function into an existing network structure.

### BACKGROUND OF THE INVENTION

In the current specifications of the third generation mobile networks (referred to as UMTS), the system utilises the same well-known architecture that has been used by all main second generation systems. A block diagram of the system architecture of the current UMTS network is presented in FIG. 1. The UMTS network architecture includes the core network (CN), the UMTS terrestrial radio access network (UTRAN), and the user equipment (UE). The core network is further connected to the external networks, i.e. the Internet, PSTN and/or ISDN and/or other public land mobile network (PLMN).

The UTRAN architecture consists of several radio network subsystems (RNS). The RNS is further divided into the radio network controller (RNC) and several base stations (BTS, referred to as Node B in the 3GPP specifications). The RNCs may have two separate logical roles with respect of the connection of UE. The RNC is called Serving RNC (SRNC) when it terminates the both the Iu link for the transport of user data and corresponding RANAP signalling to/from the CN. SRNC has also other tasks, including radio resource management operations. Drift RNC (DRNC) is any RNC other than SRNC that controls the cells used by the UE. DRNC is connected to the SRNC by Iur interface.

In this architecture there are several different connections between the network elements. The Iu interface connects CN to UTRAN. The Iur interface enables the exchange of signalling information between two RNCs. There is no equivalent interface to Iur in the architectures of the second generation mobile networks. The signalling protocol across the Iur interface is called the radio network subsystem application part (RNSAP). The RNSAP is terminated at both ends of the Iur interface by an RNC. The Iub interface connects an RNC and a Node B. The Iub interface allows the RNC and Node B to negotiate about radio resources, for example, to add and delete cells controlled by Node B to support communication of dedicated connection between UE and SRNC, information used to control the broadcast and paging channels, and information to be transported on the broadcast and paging channels. One Node B can serve one or multiple cells. UE is connected to Node B through the Uu radio interface. UE further consists of a subscriber identity module (USIM) and mobile equipment (ME). They are connected by the Cu interface. Connections to external networks are made through Gateway MSC (towards circuit switched networks) or GGSN (towards packet switched networks).

The CN (GSM CN) architecture comprises HLR (Home Location Register) that is a database for storing the master copy of the user's service profile. HLR also stores the UE location on the level of MSC/VLR (Mobile Services Switching Centre/Visitor Location Register) and/or SGSN. In FIG. 1 the CN also comprises MSC/VLR that is the switch (MSC) and database (VLR) that serves UE in its current location for circuit switched services.

The general protocol model for UTRAN Interfaces is depicted in FIG. 2, and described in detail in the following. The structure described is based on the principle that the layers and planes are logically independent of each other.

The Protocol Structure consists of two main layers, Radio Network Layer (RNL) and Transport Network Layer (TNL). These are presented in the horizontal planes of FIG. 2. All UTRAN related issues are visible only in the Radio Network Layer, and the Transport Network Layer represents the standard transport technology that is selected to be used for UTRAN but without any UTRAN-specific changes. UTRAN has certain specific requirements for TNL For instance, the real time requirement, i.e. the transmission delay has to be controlled and kept small.

The Control Plane includes the Application Protocol, i.e. RANAP (RANAP, Radio Access Network Application Part), RNSAP (RNSAP, Radio Network Subsystem Application Part) or NBAP (NBAP, Node B Application Part), that is a part of RNL, and the Signalling Bearer, that is a part of TNL, for transporting the Application Protocol messages.

The Signalling Bearer for the Application Protocol may or may not be of the same type as the Signalling Bearer for the ALCAP (ALCAP, Access Link Control Application Part). ALCAP is a generic name to indicate the protocol(s) used to establish data transport bearers on the Iu, Iur and Iub interfaces. AAL2 Signalling protocol Capability Set 2 (ITU-T Q.2630.2, a.k.a. Q.aal2 CS-2) is the selected protocol to be used as ALCAP in UTRAN. Q.2630.2 adds new optional capabilities to Q.2630.1 that is used in the first release of UTRAN.

The ITU-T Recommendation Q.2630.2 AAL type 2 Signalling Protocol (Capability Set 2) specifies the inter-node protocol and nodal functions that control AAL type 2 point-to-point connections. AAL type 2 means ATM adaptation layer type 2 (AAL2) which is an ATM adaptation layer that supports variable bit rate, connection-oriented, time-dependent data traffic. FIG. 3 is showing an example of the use of Q.2630.2 in the UTRAN context, for the different interfaces.

In the future the Internet Protocol (IP) is introduced as an transport protocol for radio access networks (RAN). So called IP RAN will introduce IP base stations (IP BTS or IP BS) that will replace in many operations the RNCs of earlier UTRAN releases. IP RANs may be connected to other RANs including UTRAN and GERAN by gateways or servers or the connections may be done directly from the IP BTSs. The IP based RAN has also been developed by 3GPP.

In Release 5 of the 3GPP 3G system (UMTS) the IP transport is introduced as an option to ATM/AAL2. ATM/AAL2 is the only transport technology in UTRAN in former releases, i.e. in Release 99 and in Release 4. The work on specifying the Release 5 IP transport is currently ongoing and the target for its completion is December 2001. The ongoing work and its results are documented in TR25.933.

Along with the introduction of a new transport option there is a need to ensure that the new and the existing technologies can co-exist and inter-work. This is considered crucial both from the operators' network evolution viewpoint as well as from the vendors' business point of view.

Also it is emphasised that the inter-working between the ATM/AAL2 and IP transport should be realised and implemented in such a way that the changes to the existing Rel99 and Rel4 technology and specifications are minimal and the inter-working “overhead” to the new technology is also limited.

The objective of the present invention is to provide a method for managing an inter-working function (IWF) in an ATM transport network. Specifically the objective of the present invention is to provide a useful mechanism for implementing an inter-working function such that a new transport protocol can be used in the interface of an existing network structure and a new structure or element. Furthermore, the objective of the present invention is to provide such an implementation that the changes to the existing technology, e.g. to the technology according to the above mentioned releases 99 and 4 and their specifications are minimal and the inter-working “overhead” to the new technology is also minimised.

The invention is characterised by what is disclosed in the independent claims.

### SUMMARY OF THE INVENTION

The area of the invention belongs to the transport technologies in RAN. There are two transport technologies in use in the transport networks (domains) and the Network Elements in these two different domains need to be able to communicate with each other. It is to be noted that the number of the transport technologies is not restricted to two.

The baseline for the invention is that the existing ATM/AAL2 network and its 3GPP specifications should be left untouched as much as possible. In RAN based on ATM/AAL2 transport there is AAL2 Signalling used as ALCAP.

Further the invention is based on the idea that the existing ALCAP, e.g. Q.2630 is used not only in the ATM/AAL2 domain as an ALCAP, i.e. no changes to the existing specifications, but also as an auxiliary control protocol in the IP transport domain. This is accomplished by using a user defined information element of said existing ALCAP. This is to say that whatever the ALCAP is, it has to have some information element the content of which can be determined by the served user. In one example it is implemented by extending the capabilities of Q.2630 by utilising its Served User Transport (SUT) Information Element. The SUT is an optional information element in the Establish request message of Q.2630 that can convey any information transparently from one AAL2 served user to another (the peer AAL2 served user). According to the above mentioned recommendations the length of the SUT is 1-254 octets. In the present invention the SUT transparently conveys all transport related information between the peer Q.2630 entities in the network. The transport related information can include the following: transport network layer address information (IP address, UDP port), transport network layer resource information like bandwidth of the connection (max, average, min), Transmission Time Interval of the transport network layer user (i.e., the source), packet size information and Quality of Service information like delay and/or jitter. Preferably SUT conveys at least the IP address and UDP port number of the originating node.

The benefits of the invention can be summarised as follows. When implementing a new type of transport layer protocol, there is no need for a new ALCAP protocol. Instead of it the existing ALCAP, i.e. Q.2630 in one example can be used also in the new protocol, e.g. IP, side. Signalling bearer for Q.2630 over IP is already available in Release 99. Further only a subset of an existing ALCAP (Q.2630) needs to be implemented in the IP based RAN nodes, thus reducing the inter-working overhead there, and only minor changes in the existing ATM/AAL2 network Elements are needed.

Further there is no need for Radio Network Layer inter-working as the standard RANAP/RNSAP/NBAP without any new Information Elements can be used. Inter-working function can be implemented and used solely in the Transport Network Layer. Neither there is need to know the type of the neighbouring RAN node (IP/ATM) in advance. The type is implicitly determined from the type of its transport layer address information, resulting either in native operation or operation with the TNL IWF. Also, thanks to the invention there is no restrictions in the location of the Inter-Working Function (IWF) but it can be either a standalone node or a part of any RAN or IP RAN node. The invention will make it easier to inter-work between different radio access networks.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating an example of the state of the art scenario relating to the present mobile network;

FIG. 2 is a general protocol model for UTRAN interfaces of FIG. 1.

FIG. 3 is a signalling diagram illustrating an example of the use of Q.2630.2 in the UTRAN context;

FIG. 4 is a block diagram that describes one embodiment of the present invention and;

FIGS. 5a-5b constitute a signalling diagram describing one embodiment of the present invention.

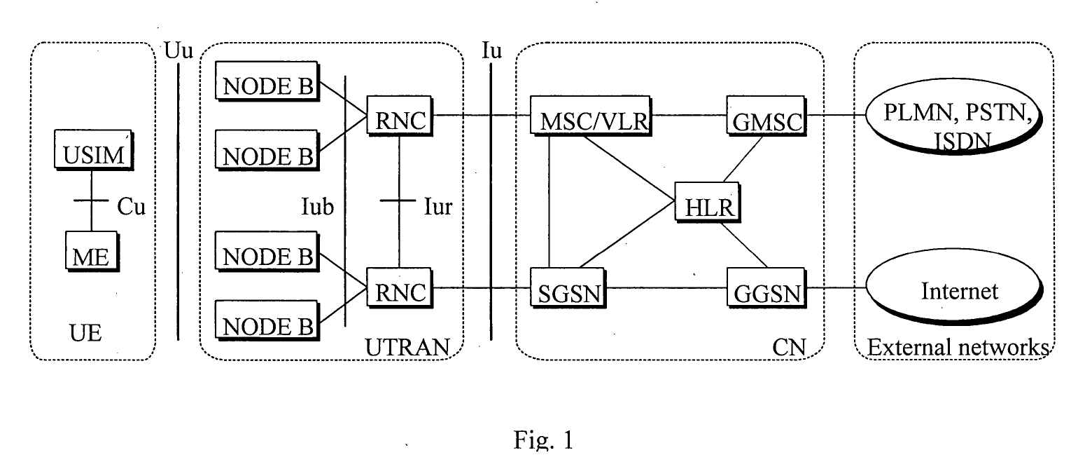

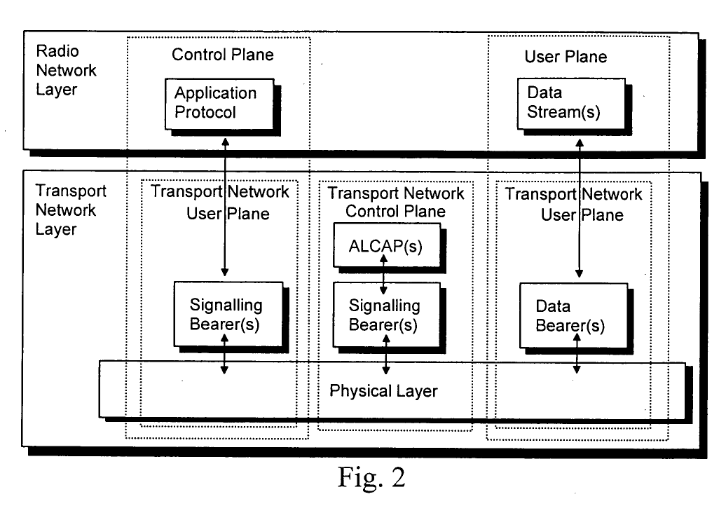

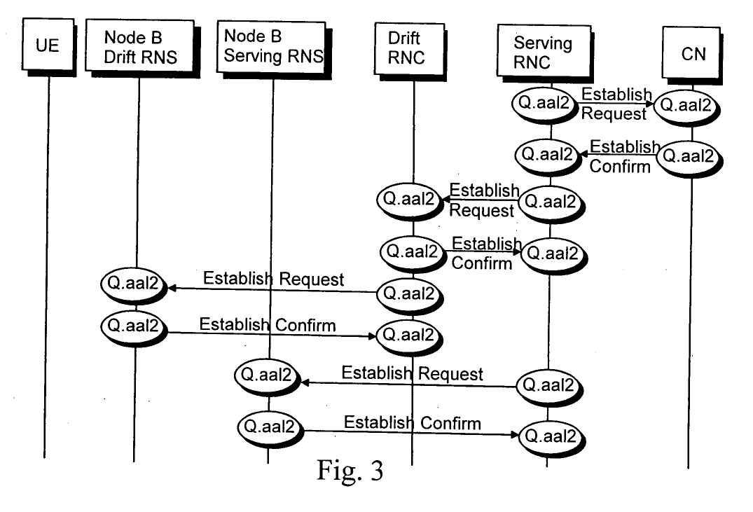

### DETAILED DESCRIPTION OF THE INVENTION

Reference will now be made in detail to the embodiments of the present invention, examples of which are illustrated in the accompanying drawings.

In the following, four different use examples for the present invention are described. The examples are related to the possible inter-working cases in the present scenario of the ATM based UTRAN network. It is to be noted that these examples are presented relating to the UTRAN and AAL2 (Q.2630) signalling as an ALCAP, and assuming that the new protocol would be IP. However, the invention is not to be restricted to these.

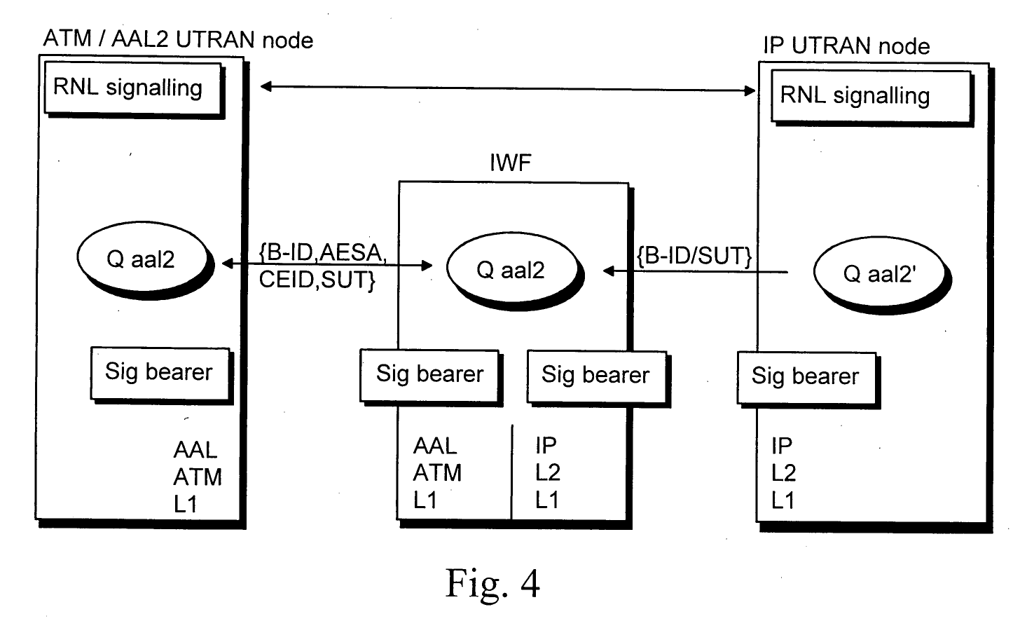

In the FIG. 4 is illustrated involved AAL2 served users and their logical location there according to one embodiment of the present invention. In FIG. 4 the left side represents the ATM/AAL2 domain and the right side the IP domain. In the middle is the Inter-working Function IWF. The IWF can be implemented as a standalone node or as part of any other network node for example IP BTS, RNC, some gateway or server.

The communication in ALCAP, i.e. Q.2630 in this example goes always via the IWF. That is, the IWF terminates the Q.2630 from both sides and is acting as an AAL2 served user. The Radio Network Layer signalling does not have to go via the IWF at all. This is one of the benefits of the present invention.

On ATM/AAL2 side the Q.2630 is used exactly in the same way as it has been specified in 3GPP UTRAN specifications so far. On IP side only the SUT (Served User Transport) Information Element and its contents as well as the Binding ID (B-ID) are relevant for the UTRAN IP node. The term Sig bearer in FIG. 4 denotes to signalling bearer of the ALCAP and it is specified in the above mentioned specifications. The notations L1 and L2 refer to terms layer 1 and layer 2, correspondingly.

In the following more detailed description of the special cases of the invention is given. In this example the embodiments of the invention cover the following cases:

Connection Establishment/Release on Iur from the ATM/AAL2 domain towards the IP domain.

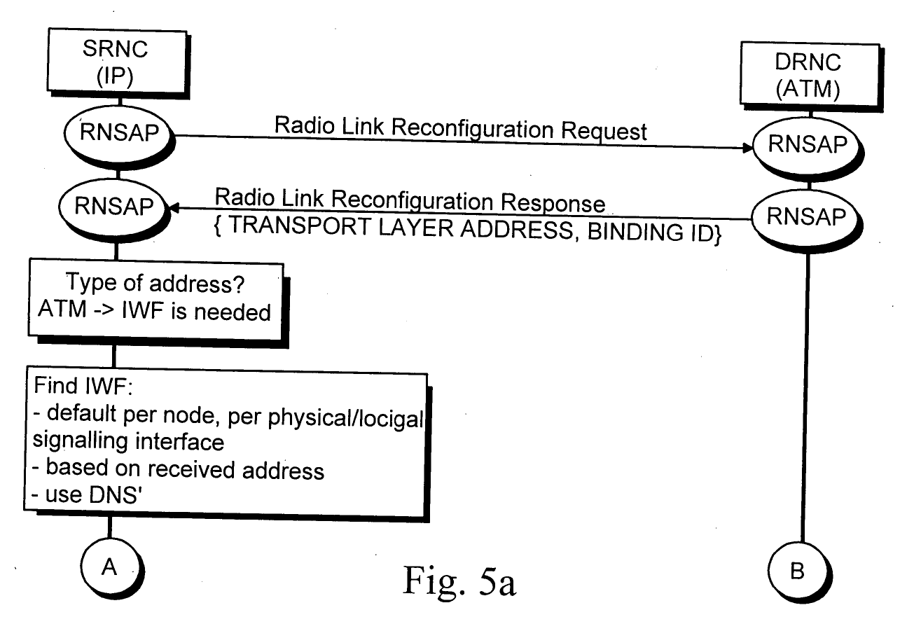

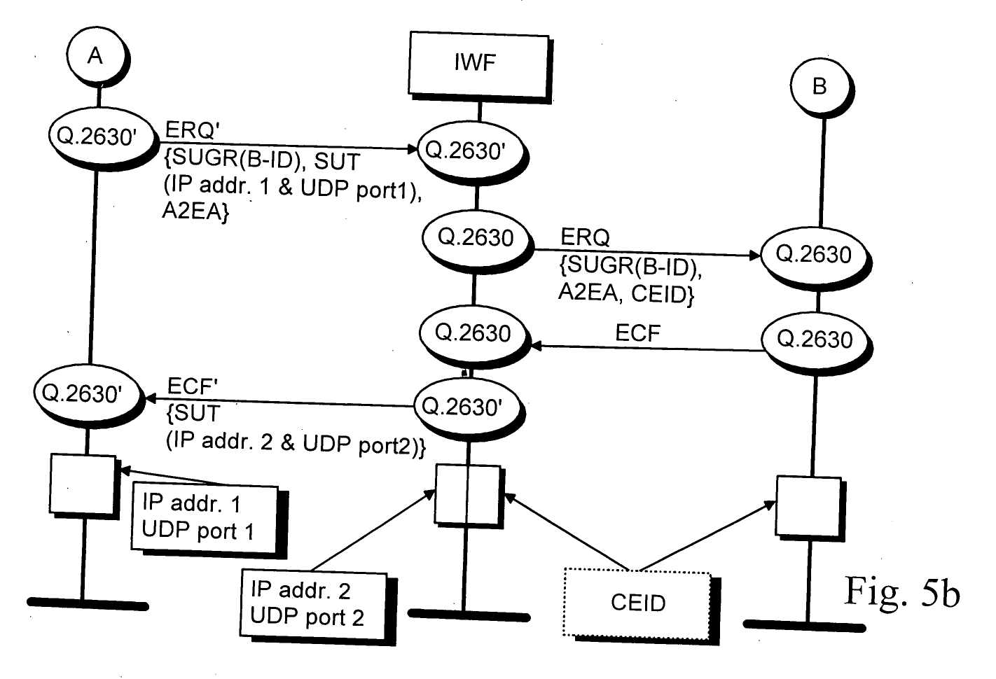

Connection Establishment/Release on Iur from the IP domain towards the ATM/AAL2 domain. This is also presented in the signalling diagram of FIGS. 5a and 5b.

Connection Establishment/Release on Iub from the ATM/AAL2 RNC to IP Base Station

Connection Establishment/Release on Iub from the IP RNC to ATM/AAL2 Base Station

It is also to be noted that on Iur interface the transport bearer is always established by the Serving RNC of the given context. So in physical sense the Iur establishment can start from either end of the Iur. On Iub the transport bearer is always established and released by the Controlling RNC. The Node B is never establishing nor releasing the Iub transport bearer. These principles are according to the current 3GPP Specifications. It is noted that the application of the invention is not restricted to these principles but the connection control procedures (establishement, release, modification via ALCAP) can be started from either side of any given interface.

In the first example SRNC on ATM/AAL2 domain starts the transport channel setup by sending the corresponding RNSAP message on Radio Network Layer. Then the Drift RNC is expected to respond by sending the RNSAP Response message. The response includes the needed transport information like destination IP address and the UDP port. In addition the Binding ID is included. The transport information is checked by the SRNC and when the destination address is other than an ATM End System Address (AESA), the SRNC application logic determines that IWF is needed. The IWF is found by either using a default IWF (per RNC, per physical signalling interface or per logical signalling interface) or by performing a search for the IWF based on the address information. That is, there can be a mapping table in the SRNC where there is an entry (IWF address(AESA)) for each IP RNC. The IWF information can also be in a centralised location somewhere in the network, accessed by each RNC similarly as domain name server (DNS) queries are done in IP world. The information the SRNC needs is the routable address of the IWF. For an RNC having only ATM/AAL2 interfaces this address needs to be an ATM End System type of address.

When the IWF address is found, the ALCAP of SRNC sends a normal Q.2630 Establish Request (ERQ) message towards the IWF. The optional Served User Transport IE is now included and it contains the transport address information that was originally received from the DRNC. When the IWF receives the ERQ, it checks the SUT and finds the IP transport information. IWF makes the mapping between the AAL2/ATM interface and the IP interface and allocates the needed resources. Then the ALCAP in the IWF sends an ERQ′ towards the DRNC. The ERQ′ represents a normal Establish Request except that the Connection Endpoint information may be null. The SUT contains now the destination address and UDP port of the IWF (the port that is used by the IWF to receive the data from the DRNC side. The binding ID (B-ID) is conveyed in the Served User Generated Reference (SUGR) IE in the normal way. The B-ID is the one that was originally allocated by the DRNC. The signalling address of the DRNC is determined by the IWF based on a default address or according to the IP address information of the DRNC (received in the SUT of ERQ from SRNC). The DRNC correlates the received ERQ′ with the corresponding transport channel setup instance by its Binding ID. The DRNC sends an acknowledgement (ECF′) back to IWF. Then the IWF sends the Q.2630 Establishment Confirm (ECF) message back to SRNC. From the SRNC viewpoint there is now a transport bearer between the SRNC and the DRNC.

The transport bearer release is by default done by the SRNC as well. On the IP side of the IWF there is no need for any TNL signalling message exchange. On the ATM/AAL2 side the release is done according to Q.2630, initiated by the RNC. The IWF releases the AAL2 connection resource and clears the through connection and the IP address & UDP port. The RNC on IP side functions similarly as in the all-IP case (i.e., no IWF); the connection resource is released based on the RNL signalling transaction. The Binding ID is not needed nor used here.

When the transport channel is established from the IP side of the Iur, see FIGS. 5a and 5b, the message sequence in RNL is exactly as it is in any other case. Now the SRNC starts the procedure by sending a radio link reconfiguration request to DRNC. The DRNC in ATM/AAL2 side sends the RNSAP response message to SRNC and it contains all the necessary transport information (B-ID, AESA) as specified in RNSAP specification [TS25.423 v3.00 (Rel99) and v4.00 (Rel4)]. When the SRNC on IP side finds out that the type of the transport address is not IP, it determines that the IWF is needed. The involved IWF (its address) is found in one of the ways described in the first case above (RNC). When the IWF is found (its signalling address) the ERQ′ is sent to it (Q.2630 over SigTran). ERQ′ contains the SUT IE conveying the destination IP address and the UDP port of the SRNC and the SUGR IE conveying the B-ID originally assigned by the DRNC and the A2EA conveying the AESA of the DRNC. As soon as the IWF receives the ERQ′ it starts the connection establishment towards the DRNC (in ATM/AAL2 domain) by sending out the regular Q.2630 ERQ with the B-ID and AESA copied from the ERQ′. DRNC then responds by sending the ECF back to IWF. When EFC is received it triggers the IWF to send ECF′ back to SRNC. This ECF′ is a regular ECF but with SUT [Note: this is the only change needed in Q.2630]. SUT conveys the IP address and UDP port of the IWF.

The transport bearer release is done by sending a Q.2630 Release message (REL′) from SRNC (IP) to the IWF. Based on the received REL′ the IWF clears the trough-connect and IP resources and sends a REL to DRNC according to Q.2630 release procedure.

On Iub all connection transport bearer control actions are initiated by the Controlling RNC of the given Base Station (BS). The transport bearer establishment is started as soon as a NBAP response is received from the BS by the RNC. The response (to the originally sent NBAP Setup Request) contains the transport layer information (Binding ID, IP address and UDP port). The RNC detects then a non-AESA address and determines that an IWF is needed. The correct IWF is found as described in case 1. Then the AL-CAP in RNC sends out the Q.2630 ERQ towards the IWF with SUT IE containing the IP transport information, SUGR containing the B-ID, etc. Also SUT IE can contain the following: transport network layer address information (IP address, UDP port), transport network layer resource information like bandwidth of the connection (max, average, min), Transmission Time Interval of the transport network layer user (i.e., the source), packet size information and Quality of Service information like delay and/or jitter requirements. Preferably SUT IE conveys at least the IP address and UDP port number of the originating node.

Receiving IWF then sends the ERQ′ to BS with SUT containing the IP address and UDP port of the IWF. The BS acknowledges by sending the ECF′ back to IWF. Then the IWF responds to RNC by sending a normal ECF to it.

The connection is released similarly as in case the first case. There is no ALCAP signalling needed in TNL on the IP side of the IWF.

The RNC with IP interface receives the NBAP respond from the BS conveying an AESA type transport address. It indicates that an IWF is needed. IWF is then found and the RNC sends an ERQ′ towards the IWF with SUT conveying the IP address and the UDP port of the RNC. SUGR conveys the B-ID. CEID is null as it is not needed in the IWF. When IWF has received the ERQ′, it starts a normal Q.2630 connection establishment towards the BS using the B-ID received in ERQ′. As soon as an ECF is received from the BS, IWF sends ECF′ to RNC, including the SUT containing the IP address and UDP port of the IWF.

The transport bearer is released by the RNC similarly as in the second case.

It is obvious to a person skilled in the art that with the advancement of technology, the basic idea of the invention may be implemented in various ways and in various network environments The invention and its embodiments are thus not limited to the examples described above, instead they may vary within the scope of the claims.

1. A method for controlling an inter-working function linked with an ATM transport network, characterised in that said inter-working function uses a user defined information element of an existing protocol, that is used for establishing the data transport bearers, to adapt a new protocol for controlling the transport bearers in the Transport Network Layer.

2. The method according to claim 1, characterised in that transport related information is conveyed in said user defined information element.

3. The method according to claim 2, characterised in that said transport related information includes at least one of the following information: transport network layer address information, transport network layer resource information, Transmission Time Interval of the transport network layer user, packet size information and Quality of Service information

4. The method according to claim 1, characterised in that said ATM transport network is used in Radio Access Network; and that said existing protocol is ALCAP protocol based on AAL2 Signalling.

5. The method according to claim 4, characterised in that said AAL2 signalling is based on ITU Recommendation Q.2630.

6. The method according to claim 5, characterised in that as said user defined information element of an existing ALCAP protocol is utilised a Served User Transport (SUT) Element of said Q.2630 signalling.

7. The method according to claim 1, characterised in that using said user defined information element in said new protocol for conveying information needed by said existing ALCAP protocol.

8. The method according to claim 1, characterised in that including said user defined information element in the Establish Confirm message of said existing ALCAP protocol.

9. The method according to claim 1, characterised in that including said user defined information element in the Establish Request message of said existing ALCAP protocol.

10. The method according to claim 2, characterised in that when receiving an address information of an Radio Access Network node,
the check is made whether said address information is compatible with an address space of receiving protocol, and if said address information is not compatible,
the address of said inter-working function is determined.

11. The method according to claim 10, characterised in that the address of said inter-working function is determined by default for each network node.

12. The method according to claim 10, characterised in that the address of said inter-working function is queried from a centralised location in said network.

13. The method according to claim 10, characterised in that the address of said inter-working function is determined based on a physical port from which Application Protocol message was received.

14. The method according to claim 10, characterised in that the address of said inter-working function is determined based on a logical port from which Application Protocol message was received.

15. The method according to claim 10, characterised in that said check is made using a type of address information field that indicates at least one of the following set including, the type of a network node, a type of address and a type of Transport Layer.

16. The method according to claim 10, characterised in that said check is made using a type of node information field that indicates at least one of the following set including, the type of a network node, a type of address and a type of Transport Layer.

17. The method according to claim 7, characterised in that said check is made using a type of transport layer information field that indicates at least one of the following set including, the type of a network node, a type of address and a type of Transport Layer.

18. The method according to claim 1, characterised in that mapping between the first interface of said existing protocol and the second interface of said new protocol is made in said inter-working function based on information in said user defined element.

19. The method according to claim 1, characterised in that said inter-working function is implemented as a stand-alone node in said ATM transport network.

20. The method according to claim 1, characterised in that said inter-working function is implemented as a stand-alone node in a transport network.

21. The method according to claim 1, characterised in that said inter-working function is implemented as a part of a network node in said ATM transport network.

22. The method according to claim 1, characterised in that said inter-working function is implemented as a part of a network node in a transport network.

23. The method according to claim 20, characterised in that said transport network is based on IP network.

24. A System for controlling an inter-working function linked with an ATM transport network, characterised in that said inter-working function comprises
a mapping entity that is arranged to use a user defined information element of an existing protocol, that is used for establishing the data transport bearers, to adapt a new protocol for controlling the transport bearers in the Transport Network Layer.

25. The system according to claim 24, characterised in that said ATM transport network is used in Radio Access Network; and that said existing protocol is ALCAP protocol based on AAL2 Signalling.

26. The system according to claim 25, characterised in that said AAL2 signalling is based on ITU Recommendation Q.2630.

27. The system according to claim 26, characterised in that as said user defined information element of an existing protocol is utilised a Served User Transport (SUT) Element of said Q.2630 signalling.

28. The system according to claim 24, characterised in that the system further comprises
a checking entity for making a check whether an address information is compatible with an address space of receiving protocol, when receiving an address information of an Radio Access Network node; and
an address determining entity for determining the address of the said inter-working function.
